(19) United States
(12) Patent Application Publication
(10) Pub. No.: US 2022/0405508 A1
(43) Pub. Date: Dec. 22, 2022

(54) OBJECT INFORMATION ASSOCIATION METHOD AND APPARATUS, DEVICE AND STORAGE MEDIUM

(71) Applicant: SENSETIME INTERNATIONAL PTE. LTD., Singapore (SG)

(72) Inventors: Zhiyang GUO, Singapore (SG); Xinxin Wang, Singapore (SG)

(21) Appl. No.: 17/364,308

(22) Filed: Jun. 30, 2021

Related U.S. Application Data
(63) Continuation of application No. PCT/IB2021/055681, filed on Jun. 25, 2021.

(30) Foreign Application Priority Data
Jun. 16, 2021 (SG) 10202106446P

(51) Int. Cl. G06K 9/00; G06K 9/62

(52) U.S. Cl. CPC G06K 9/00718; G06K 9/6201; G06K 9/00228

(57) ABSTRACT

Embodiments of the present application provide an object information association method and apparatus, a device and a storage medium. The method includes that: based on a video stream of an object operation region, a first object and a second object that are mutually associated are detected in the object operation region; first object information of the first object is determined; the second object is matched with a preset second object in a preset second object library; in a case where the second object fails to be matched with the preset second object, a request for acquiring second object information of the second object is sent; and in a case where the second object information sent in response to the request is received, the first object information is associated with the received second object information.

### CROSS-REFERENCE TO RELATED APPLICATION

This is continuation application of international application PCT/IB2021/055681, filed on 25 Jun. 2021, which claims priority to Singaporean patent application No. 10202106446P, filed with IPOS on 16 Jun. 2021. The contents of international application PCT/IB2021/055681 and Singaporean patent application No. 10202106446P are incorporated herein by reference in their entireties.

### TECHNICAL FIELD

Embodiments of the present application relate to the technical field of image processing, and relate, but are not limited, to an object information association method and apparatus, a device and a storage medium.

### BACKGROUND

In game sites, standards for gamers and game managers are crucial. In the related art, as management systems of the game sites cannot capture clear face information images of the gamers, games cannot be effectively managed to proceed normally and smoothly.

### SUMMARY

The embodiments of the present application provide technical solutions for object information association.

The technical solutions in the embodiments of the present application are implemented as follows.

The embodiments of the present application provide an object information association method, which may include the following operations.

Based on a video stream of an object operation region, a first object and a second object that are mutually associated in the object operation region are detected.

First object information of the first object is determined.

The second object is matched with a preset second object in a preset second object library.

In a case where the second object fails to be matched with the preset second object, a request for acquiring second object information of the second object is sent.

The first object information is associated with the received second object information in a case where the second object information sent in response to the request is received.

In some embodiments, in a case where the second object is successfully matched with the preset second object, second object information of the successfully matched preset second object is acquired from the preset second object library; and the first object information is associated with the second object information of the successfully matched preset second object. Therefore, the second object information matched in the preset second object library is automatically associated with the first object information, such that the rate for associating the first object and the second object can be improved.

In some embodiments, the operation that based on the video stream of the object operation region, the first object and the second object that are mutually associated in the object operation region are detected may include that: the first object and the second object are detected based on the video stream of the object operation region, where the first object is an object capable of being operated, and the second object is an object capable of executing an operation behavior; an operation relationship between each first object and each second object is detected; and for each first object, a second object detected to have an operation relationship with the first object is determined as the second object mutually associated with the first object. Therefore, by analyzing the operation relationship between the first object and the second object, the second object mutually associated with the first object can be accurately searched.

In some embodiments, the operation that based on the video stream of the object operation region, the first object and the second object that are mutually associated in the object operation region are detected may further include that: for each first object, in a case where the second object having the operation relationship with the first object is not detected, it is determined that the object operation region does not have the second object mutually associated with the first object. Therefore, by analyzing the operation relationship between the first object and the second object, whether the object operation region has the second object mutually associated with the first object can be quickly determined.

In some embodiments, the object operation region may include a game prop operation region, the first object may include a game prop, the second object may include a game participant, and the operation that based on the video stream of the object operation region, the first object and the second object that are mutually associated in the object operation region are detected may include that: in a case where a game stage in the object operation region is determined as a preset first object operation stage based on the video stream, a game prop and a game participant that are mutually associated in the object operation region are detected based on the video stream of the object operation region. Therefore, by determining the game stage in which the object operation region is located, the first object and the second object that are mutually associated are detected, to facilitate targeted management on the operation stage of the game.

In some embodiments, the operation that in the case where the second object fails to be matched with the preset second object, the request for acquiring the second object information of the second object is sent may include that: in a case where the first object meets a preset candidate object condition and the second object fails to be matched with the preset second object, the request for acquiring the second object information of the second object is sent. Therefore, by feeding the request for acquiring the second object information of the second object back to the management end, the manager at the management end manually acquires the second object information and feeds back the second object information.

In some embodiments, before in the case where the first object meets the preset candidate object condition and the second object fails to be matched with the preset second object, the request for acquiring the second object information of the second object is sent, the method may further include that: configuration information of the object association operation is acquired, the configuration information including on-off state information of a manual association object function and object type information corresponding to the manual association object function; and in a case where the on-off state information indicates that the manual association object function is enabled, it is determined that the candidate object condition includes a type of an object being consistent with the object type information. Therefore, not only the association relationship between the first object and the second object can be established, but the unnecessary calculated amount can be reduced.

In some embodiments, the operation that based on the video stream of the object operation region, the first object and the second object that are mutually associated in the object operation region are detected may further include that: for each first object, in the case where the second object having the operation relationship with the first object is not detected, an association Identity Document (ID) of the first object is acquired; and based on the association ID, a request for acquiring a second object having an operation relationship with the first object is sent. Therefore, by feeding the association ID of the first object to the management end, the manager may search, according to the association ID, the object mutually associated with the first object.

In some embodiments, the object operation region may include a game prop operation region, the first object may include a game prop, and the second object may include a game participant; and before the second object is matched with the preset second object in the preset second object library, the method may further include that: a face image and identity information of a gamer entering the game prop operation region are acquired; and the preset second object library is established based on the face image and the corresponding identity information of the game participant. Therefore, by acquiring the historical gamer or onlooker entering the game site, the more abundant second object library can be established.

In some embodiments, the first object information may include a tracking ID of the game prop, and the second object information may include: a face image and/or identity information of the second object. Therefore, by binding the tracking ID of the first object with the face image and/or the identity information of the second object, the first object information and the second object information are associated to implement the low cost and the high association speed.

In some embodiments, the operation that in the case where the second object fails to be matched with the preset second object, the request for acquiring the second object information of the second object is sent may further include that: alarm information is sent in the case where the second object fails to be matched with the preset second object; and the alarm information is removed in a case where it is detected that the first object is moved out of the object operation region. Therefore, the alarm information is removed in the case where it is detected that the first object is moved out of the object operation region, to reduce the workload of a person at the management end.

In some embodiments, the request may include: first object information of a first object associated with the second object that fails to be matched with the preset second object, and after in the case where the second object fails to be matched with the preset second object, the request for acquiring the second object information of the second object is sent, the method may further include that: association information sent in response to the request is received, where the association information may include the first object information and the second object information associated with the first object information. Therefore, the process for establishing the association relationship between the first object and the second object is simple in logic, strong in constraint condition and easy in implementation, and can ensure the association accuracy.

In some embodiments, the method may further include that: image information of the second object is extracted from the video stream; and the request may further include: image information of the second object that fails to be matched with the preset second object. Therefore, the image of the game prop not associated to the gamer information and the face image of the gamer associated with the game prop are carried in the alarm information, such that the game manager queries a person list, and can accurately associate the game prop with the gamer.

The embodiments of the present application provide an object information association apparatus, which may include: a first detection module, a first determination module, a first matching module, a first sending module and a first association module.

The first detection module is configured to detect, based on a video stream of an object operation region, a first object and a second object that are mutually associated in the object operation region.

The first determination module is configured to determine first object information of the first object.

The first matching module is configured to match the second object with a preset second object in a preset second object library.

The first sending module is configured to send, in a case where the second object fails to be matched with the preset second object, a request for acquiring second object information of the second object.

The first association module is configured to associate the first object information with the received second object information in a case where the second object information sent in response to the request is received.

Correspondingly, the embodiments of the present application provide a computer storage medium, which stores a computer executable instruction; and after executed, the computer executable instruction, when executed, implements steps of the above method.

The embodiments of the present application provide a computer device, which may include a memory and a processor; the memory stores a computer executable instruction; and the processor, when running the computer executable instruction in the memory, implements steps of the above method.

According to the object information association method and apparatus, the device and the storage medium provided by the embodiments of the present application, first of all, the video stream of the object operation region is detected to determine the first object and the second object that are mutually associated; then, in the case where the preset second object matched with the second object is not found in the preset second object library, the request for acquiring the second object information of the second object is sent to the management end; the management end manually acquires the second object information, and feeds back the second object information; and at last, the received second object information is associated with the first object information. Therefore, in the case where the preset second object is not matched in the preset second object library, the request for acquiring the second object information is sent, such that the management end feeds back the second object information, thereby improving the accuracy for associating the first object information and the second object information.

### BRIEF DESCRIPTION OF THE DRAWINGS

FIG. 1 is an implementation flowchart of an object information association method provided by an embodiment of the present application.

FIG. 2 is another implementation flowchart of an object information association method provided by an embodiment of the present application.

FIG. 3 is a structural schematic diagram of a hot region map provided by an embodiment of the present application.

FIG. 4 is another structural schematic diagram of a hot region map provided by an embodiment of the present application.

FIG. 5 is still another structural schematic diagram of a hot region map provided by an embodiment of the present application.

FIG. 6 is an implementation flowchart of a game site management method provided by an embodiment of the present application.

FIG. 7 is a structural schematic diagram of an object information association apparatus provided by an embodiment of the present application.

FIG. 8 is a structural schematic diagram of a computer device provided by an embodiment of the present application.

### DETAILED DESCRIPTION

To make the objectives, technical solutions, and advantages of the present application clearer, the specific technical solutions of the present application are described below in detail with reference to the accompanying drawings in the embodiments of the present application. The following embodiments are used for illustrating the present application rather than limiting the scope of the present application.

In the following descriptions, “some embodiments” are involved, which describes subsets of all possible embodiments. However, it may be understood that the “some embodiments” may be the same subsets or different subsets of the all possible embodiments, and may be combined with each other without conflicts.

In the following descriptions, the terms “first/second/third” related are merely for distinguishing similar objects rather than a special order of the objects. It is to be understood that the “first/second/third” may exchange a special sequence or chronological sequence in an allowed condition, such that the embodiments of the present application described herein can be implemented in a sequence other than that illustrated or described herein.

Unless otherwise defined, all technical and scientific terms used herein have a same meaning generally understood by those skilled in the art to which the present application belongs. The terms used herein are merely to describe the embodiments of the present application, rather than to limit the present application.

The descriptions are made to the nouns and terms in the embodiments of the present application before the embodiments of the present application are further described in detail. The nouns and terms in the embodiments of the present application are applied to the following explanations.

1) Computer vision is a science for researching how to use a machine to “see”, and refers to that a camera and a computer are used to replace human eyes to recognize, track and measure an object, and further perform image processing.

2) Portrait information of the gamer, as a base of big data, abstracts whole information of one gamer perfectly, provides sufficient data bases to further accurately and quickly analyze behavioral habits, consumption habits and other important information of users, and lays the foundation for the era of big data. In brief, the gamers are tagged; and the tags are highly refined feature IDs obtained by analyzing user information. By tagging, the gamers may be described with some features that are highly generalized or easily understood, which may make a person understand the gamers more easily, and may facilitate computer processing.

The following descriptions are made to exemplary applications of an object information association device provided by the embodiments of the disclosure. The device provided by the embodiments of the disclosure may be implemented as various types of user terminals having an image collection function, such as the notebook, tablet, desktop computer, camera and mobile device (for example, the Personal Data Assistant (PDA), special messaging device and portable game device), and may also be implemented as a server. The descriptions are made below to the exemplary application in which the device is implemented as the terminal or the server.

The method may be applied to a computer device. Functions implemented by the method may be implemented by a processor in the computer device calling a program code. Certainly, the program code may be stored in a computer storage medium. Hence, the computer device at least includes the processor and the storage medium.

The embodiments of the present application provide an object information association method, which may be as shown in FIG. 1, and described in combination with steps shown in FIG. 1.

In Step S101, based on a video stream of an object operation region, a first object and a second object that are mutually associated in the object operation region are detected.

In some embodiments, the video stream is video data collected for the first object and the second object in the same game scenario. The object operation region is a region where the second object operates the first object. The mutually associated first object and second object indicate that the second object operates the first object.

In Step S102, first object information of the first object is determined.

In some embodiments, the first object information includes a type of the first object, an ID of the first object and a tracking ID of the first object. With a case where the object operation region is the game prop operation region as an example, by acquiring a present frame of image of the game and recognizing the first object in the present frame of image, the first object information may be obtained. The first object information includes the tracking ID of the game prop. Based on the tracking ID of the game prop, the tracking on a game operation behavior of the second object processing the game prop may be implemented, and the operation of the manager during the game can further be standardized, such that the whole game process meets the game standard.

In Step S103, the second object is matched with a preset second object in a preset second object library.

In some embodiments, the second object library includes images of multiple second objects and second object information. The preset second object having a similarity with the second object more than a similarity threshold is searched in the second object library. Feature extraction is performed on an image of the second object to obtain image features. For example, a convolutional neural network may be used to perform the feature extraction on the image of the second object to obtain the image features. The preset second object is searched in the preset second object library based on the image features. For example, based on the extracted image features, by calling the preset second object library, the image with a high similarity is searched. Therefore, based on the searched image with the high similarity, the image of the preset second object is found in the preset second object library in a manner of searching the image with the image, which is simple and easy in implementation, and has the high accuracy.

In Step S104, in a case where the second object fails to be matched with the preset second object, a request for acquiring second object information of the second object is sent.

In some embodiments, if the preset second object having the high similarity (for example, the similarity is more than a set threshold) with the second object is not found in the second object library, the request for acquiring the second object information of the second object is sent to the management end. The second object information includes face information of the second object and identity information of the second object. Upon the reception of the request, the management end manually acquires the second object information according to the second object, and feeds back the acquired second object information.

In Step S105, the first object information is associated with the received second object information in a case where the second object information sent in response to the request is received.

In some embodiments, the second object corresponding to the second object information is an object operating the first object. As the first object is associated with the second object, the first object information is associated with the received second object information, to indicate that the second object operates the first object. With a case where the object operation region is the game prop operation region as an example, the second object is a participant of the game, and the first object is a game prop of the game. With the case where the object operation region is the game prop operation region as the example, the second object information includes: a face image and/or identity information of the second object. By acquiring a present frame of image of the game, different body parts such as a face, a body and a hand of the gamer are recognized in the present frame of image; identity information of the gamer is searched in a playground system of the game based on the identified gamer face, to obtain the identity information and image of the gamer of the game. After the present frame of image of the game is collected, a game stage may be determined by recognizing the present frame of image; and gamer information of the game may be obtained through recognition on the present frame of image. In this way, by recognizing the game prop of the game and the gamer image of the game in the present frame of image, the gamer image of the game is associated with the game prop operated by the gamer, thereby establishing an association relationship between the game prop and the gamer. By assigning the image and identity information of the preset second object to the first object, the first object is bound with the image and identity information of the preset second object, to establish an association relationship between the first object and the preset second object. Therefore, by automatically querying the image and identity information of the preset second object in the preset second object library, the first object is associated with the preset second object to implement the low cost and the high association speed.

In the embodiment of the present application, in a case where the preset second object is not matched in the preset second object library, a request for acquiring the second object information is sent, such that the management end feeds back the second object information, and thus the accuracy of associating the first object information with the second object information can be improved.

In some embodiments, if the preset second object can be matched in the preset second object library, the second object information of the preset second object is acquired from the second object library, i.e., after Step S103, the method may further include the following steps S106 and S107 (not shown in the figure).

In Step S106, in a case where the second object is successfully matched with the preset second object, second object information of the successfully matched preset second object is acquired from the preset second object library.

In some embodiments, the preset second object is matched in the preset second object library, i.e., the preset second object library includes the preset second object having the high similarity with the second object; and in the preset second object library, the second object information of the preset second object is acquired.

In Step S107, the first object information is associated with the second object information of the successfully matched preset second object.

In some embodiments, by associating the first object information with the matched second object information in the preset second object library, the first object and the second object that are associated together can be managed. Therefore, the second object information matched in the preset second object library is automatically associated with the first object information, such that the rate for associating the first object and the second object can be improved.

In some embodiments, by analyzing an operation relationship between the first object and the second object, whether the first object and the second object are mutually associated can be determined, i.e., the above Step S101 may be implemented through the following Step S111 to Step S114 (not shown in the figure).

In Step S111, the first object and the second object are detected based on the video stream of the object operation region.

In some embodiments, the first object is an object capable of being operated, and the second object is an object capable of executing an operation behavior. With the game as an example, the first object may be the game prop in the game, and the second object is the participant of the game. In the collected video stream of the object operation region, the first object and the second object included in the video stream are detected. There may be one or more first objects, and one or more second objects.

In Step S112, an operation relationship between each first object and each second object is detected.

In some embodiments, the affiliation relationship between the first object and the second object may be that one second object may operate multiple first objects, and one first object can only be operated by one second object. The operation relationship includes: the first object is operated by the second object, or the first object belongs to the second object.

In Step S113, for each first object, a second object detected to have an operation relationship with the first object is determined as the second object mutually associated with the first object.

In some embodiments, for each first object, an operation relationship of the first object with each second object, i.e., whether the first object is operated by the second object, is analyzed. If the first object is operated by some second object, it is indicated that the first object is mutually associated with the second object; and an operation relationship of another first object with each second object is continuously detected, to determine a second object mutually associated with the another first object.

In Step S114, for each first object, in a case where the second object having the operation relationship with the first object is not detected, it is determined that the object operation region does not have the second object mutually associated with the first object.

In some embodiments, for one first object, if a second object matched with the first object is not detected, it is indicated that there is no second object operating the first object in the scenario, and then determined that the object operation region does not have the second object mutually associated with the first object.

In other embodiments, in a case where it is determined that the object operation region does not have the second object mutually associated with the first object, prompt information may be fed back to the management end, to prompt the management end of manually searching, based on the ID of the first object, the second object associated with the first object.

In the embodiment of the present application, by detecting the operation relationship between each first object and each second object in the object operation region, the second object having the operation relationship with the first object can be detected, and thus object information of the first object and the second object can be accurately associated.

In some embodiments, with a case where the object operation region includes a game prop operation region, the first object includes a game prop, and the second object includes a game participant as an example, by determining a game stage of the object operation region, the first object and the second object that are mutually associated are detected, i.e., the above Step S101 may include the following operation.

In a case where a game stage in the object operation region is determined as a preset first object operation stage based on the video stream, a game prop and a game participant that are mutually associated in the object operation region are detected based on the video stream of the object operation region.

In some embodiments, the game in the object operation region may be a gambling game, a competitive game, a puzzle game or the like. The game participant included in the second object may be a gamer or a game manager.

In some possible implementation modes, the operation process of the game is divided into multiple stages by analyzing requirement conditions of the participants during the game, to facilitate targeted management on the operation stage of the game, which may be implemented by the following process.

In a first step, an operation process for completing the game is determined.

In some embodiments, for a game, a whole implementation process for the game, i.e., an operation process for completing the game, is acquired. For example, with a case where the game is the gambling game as an example, the whole implementation process includes the following game stages: processes for preparing to start gaming, adding a manager, adding a gamer and outputting a game result.

In a second step, the operation process is divided into multiple game stages based on a personnel requirement in game operation.

In some embodiments, in the case where the game is the gambling game, the operation process is divided by analyzing requirements on persons in operation to implement the game. For example, in the case where the game is the gambling game, the whole implementation process includes: the processes of preparing to start gaming, adding the manager, adding the gamer and outputting the game result, etc. Based on requirements of these processes on the persons, the implementation process is divided into an idle state (i.e., there is no need to add the person), a gambling state (there is a need to add the gamer and the manager), a game halt state (although the persons are added, the operation of some persons is illegal) and a game end state.

In a third step, in the case where the game is the gambling game, among the multiple game stages, it is determined that the stage needing participation of the gamer and the game manager is a preset first object operation stage.

In some embodiments, in the case where the game is the gambling game, if the game is in the state needing the participation of the gamer and the game manager, it is indicated that the game is in progress. In order to ensure that the game can be proceeded legally and orderly, there is a need to manage the game in such a state, i.e., the gambling state is used as a preset state needing to be managed. Therefore, by dividing the operation process of the game into different game stages according to the condition of the person participated in the game, and taking the state needing the participation of the person as the preset state, more targeted management can be performed on the game.

With the case where the game is the gambling game as the example, the operation process of the game is divided into multiple states, such as an idle state, a gambling state, a game result output state and a halt stage. The idle state refers to a state after a service system is powered on; and in this state, the service system does not send service data or alarm information to other systems in the game site. The gambling state refers to a stage in which the gamer or the game manager participates. The game result output state refers to a stage in which the game is ended and a game win-lose result is output. The halt stage refers to a stage in which the game is halted due to an illegal operation of the game manager in the gaming process. By analyzing the present operation stage of the game, the game stage in which the game is located is determined.

In some possible implementation modes, by acquiring an image of the game at a present moment, and recognizing the game stage in the image, the game stage of the game is determined. In the case where the game is the gambling game, the game is the game on a game table, and the game stage of the game may be determined through the following process.

In a first step, a present frame of image of the game on the game table is acquired.

In some embodiments, in the case where the game is the gambling game, the game is a game that is proceeded on the game table and has participation of multiple gamers and a manager. The game table for proceeding the game may have different specifications. Through a camera disposed on the game table, a present frame of image including a game picture of the game and gamers on the game table is collected. That is, the collected present frame of image includes the game picture and the gamer image. By analyzing the present frame of image, the game stage of the game, the token included in the game, the behavior of the gamer and the like may be determined.

In a second step, a game stage is determined based on the present frame of image.

In some embodiments, multiple cameras are arranged on the game table to collect the present frame of image; and an object, a coordinate and a behavior on the table are detected, and converted into a computer language to transmit to a service module for analysis, thereby determining the game stage, and further determining whether the game stage of the game is in the gambling state. Therefore, by collecting the present frame of image of the game with the cameras on the game table, the game stage of the game is recognized, and thus the accuracy of detecting the game stage can be improved.

In some possible implementation modes, according to a hot region map divided by different table types, data recognized in the present frame of image is mapped to different hot regions for filtering, and service modules corresponding to different hot regions are different. In this way, the service module may process data in the corresponding hot region according to own service and detection functions, and thus can determine the game stage of the game. For example, the game type is the gambling game, and the preset first object operation stage is the gambling state; the game type is the puzzle game, and the preset first object operation stage is the state in which the gamer participate, etc. With the case where the game is the gambling game as an example, if the game type is the gambling type, first of all, by recognizing a game prop included in the present image of the game at the present moment, multiple game props, such as a token set, included in the game are determined. The token set may include tokens of different types, different patterns or different game values. Then, the token set is associated with the gamer possessing the token to obtain the first object and the second object that are mutually associated. Therefore, by establishing an association relationship between the token and the gamer possessing the token, and by tracking the token, the gamer operating the token may be managed.

In some embodiments, by analyzing whether the first object meets a preset candidate object condition, and whether the second object fails to be matched with the second object, whether the request for acquiring the second object information is sent to the management end is determined, i.e., the above Step S103 may be implemented through the following process.

In a case where the first object meets a preset candidate object condition and the second object fails to be matched with the preset second object, the request for acquiring the second object information of the second object is sent.

In some embodiments, the preset candidate object condition is that the first object has a type consistent with object type information corresponding to a pre-configured manual association function. In a case where the manual association object function is enabled, whether the first object meets the preset candidate object condition is analyzed. If the first object meets the preset candidate object condition, and the preset second object is not matched in the preset second object library, the request for acquiring the second object information of the second object is fed back to the management end, such that the manager of the management end manually acquires the second object information and feeds back the second object information.

In some possible implementation modes, whether a set value of the manual association function is set to be enabled is determined by acquiring a configuration file from a message-oriented middleware, which may be implemented through the following process.

In a first step, configuration information of the object association operation is acquired. Configuration information of the game is acquired.

In some embodiments, the configuration information includes on-off state information of the manual association object function and object type information corresponding to the manual association object function. The on-off state information includes: an enabled state and a disabled state; and the object type information corresponding to the manual association object function includes types of multiple first objects, i.e., types of first objects that need to be manually associated. In other embodiments, the configuration information further includes: configuration parameters of a cloud and an edge terminal, for example, configuration of an operation platform, configuration of an operation desktop and the like, and the configuration information is configured to characterize relevant setting parameters of the object association operation in a system of the corresponding site. In a specific example, with a case where the object association operation is game management as an example, a configuration file sent by a playground system of the game site is monitored in real time through the message-oriented middleware; and the configuration file is updated in real time, to ensure that the function is detected according to requirements of the playground system of the game site.

In a second step, in a case where the on-off state information indicates that the manual association object function is enabled, it is determined that the candidate object condition includes a type of an object being consistent with the object type information.

In some embodiments, if the manual association object function is enabled, the candidate object condition is set as: the type of the first object is consistent with the object type information in the configuration information. That is, if the type of the first object is consistent with the object type information, it is indicated that the type of the first object meets the candidate object condition. Therefore, whether the manual association object function is enabled is determined; and if the manual association function is enabled, whether the first object recognized in the present frame of image is included in the object type information of the configuration information is determined, and thus the unnecessary calculated amount can be reduced. With the game as an example, if the manual association function is enabled, whether the type of the game prop recognized in the present frame of image is included in the game prop type of the configuration information is determined. In this way, for the game prop in the game prop type of the configuration information, the game prop is associated with the gamer information, such that not only can the association relationship between the game prop and the gamer be established, but the unnecessary calculated amount can be reduced.

In some embodiments, for the detected first object of the mutually associated second object, the association ID of the first object is fed back to the management end, such that the manager may search an object mutually associated with the first object according to the association ID, which may be implemented through the following steps.

In a first step, for each first object, in the case where the second object having the operation relationship with the first object is not detected, an association ID of the first object is acquired.

In some embodiments, for first objects having types of the first objects consistent with the object type information, some first objects not associated to the second object are filtered. For these first objects, association IDs of the first objects are recognized. The association ID is configured to uniquely represent the first object. The association ID of the first object is generated at the algorithm side in a from of a key value, so as to be associated with the second object information of the preset second object, i.e., the association ID is associated with the hand, body, face and identity information of the preset second object. In some possible implementation modes, the unique ID set for the first object is used as the key at the algorithm side, and position information of the first object in the whole operation process is used as the value, to generate the association ID.

In a second step, based on the association ID, a request for acquiring a second object having an operation relationship with the first object is sent.

In some embodiments, the association ID is sent to the management end; and for each first object, the management end associates each first object with the second object in an artificial association manner, or automatically associates the first object with the second object by using an association algorithm. Therefore, for the first object not associated to the second object, a manual association request is sent to the management end, to prompt the management end of focusing on these first objects. With the game as an example, for the game prop not associated to the gamer, a request for acquiring the mutually associated gamer is sent to the management end of the game based on the association ID of the game prop, to prompt the game manager of focusing on these game props.

In some embodiments, the object operation region includes a game prop operation region, the first object includes a game prop, and the second object includes a game participant. By acquiring a historical gamer or onlooker entering the game site, the second object library including gamer images and corresponding identity information is established, which may be implemented through the following steps.

In a first step, a face image and identity information of a gamer entering the game prop operation region are acquired.

In some embodiments, before the image of the preset second object is queried, a gamer image and corresponding identity information of a historical gamer entering the game site, as well as a gamer image and corresponding identity information of a present gamer are acquired.

In a second step, the preset second object library is established based on the face image and the corresponding identity information of the game participant.

In some embodiments, in the established preset second object library, gamer images and identity information of gamers are stored in correspondence, such that the gamer image of the preset second object can be queried according to the gamer images in the preset second object library. With a case where the object operation region is the game prop operation region as an example, the first object is the game prop, the second object is the gamer, and the preset second object library includes gamer images and corresponding identity information of gamers. The preset gamer list is gamer images and identity information of gamers entering the game site and historically recorded in the playground system, and gamer images and identity information of gamers entering the game site and recorded presently. After the preset second object library is established, the second object library is stored to a cache system. In the cache system, after the gamer image is queried, a face image of a preset second object having a high similarity with the gamer image is searched in the second object library in a manner of searching the image with the image.

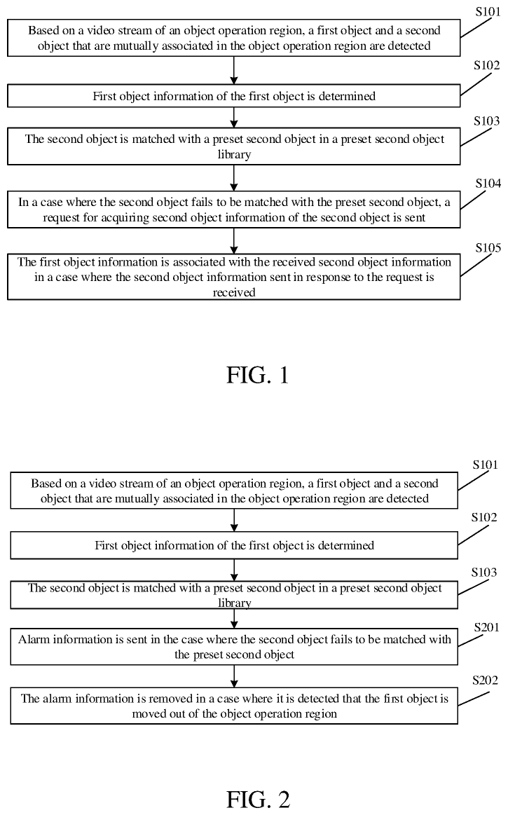

In some embodiments, after the case for acquiring the second object information is sent to the management end, if it is detected that the first object is moved out of the object operation region, the alarm sent to the management end is removed, which may be implemented through steps shown in FIG. 2.

In Step S201, alarm information is sent in the case where the second object fails to be matched with the preset second object.

In some embodiments, for the second object mutually associated with the first object, if the preset second object matched with the second object is not found in the preset second object library, the alarm information is sent to the management end that can manually associate the first object with the second object, to prompt of that the second object may be an unfamiliar object, such that the user knows that the second object is not included in the second object library.

In Step S202, the alarm information is removed in a case where it is detected that the first object is moved out of the object operation region.

In some embodiments, in a case where it is detected that the first object disappears from the object operation region, it is indicated that there is no need to search the mutually associated second object for the first object, and thus the alarm information is removed. With a case where the object operation region is the game, the first object is the token of the game and the second object is the gamer as an example, in a case where a preset second object having a high similarity with the gamer is not found in the preset second object library, the alarm information is sent to the management end of the game, to prompt the game manager of that the gamer of the token is not included in the preset second object library; and in a case where it is detected that the token disappears from the game table, the alarm information is removed, to notify the game manager of not continuing to search the gamer mutually associated with the token. In some possible implementation modes, an edge device in the playground system of the game site takes position information and a tracking ID of the token as alarm information, and transmits the alarm information to the playground system through a websocket, to prompt the manager of artificially associating the token, and the process is as follows.

In a first step, the alarm information sent by the edge device and generated based on the tracking ID of the token is received.

In some embodiments, the tracking ID carries the position information of the token. The edge device generates the tracking ID for the token, and carries a position where the token is located in a gaming process in the tracking ID. The tracking ID carrying the position information is used as the alarm information to send to the playground system.

In a second step, the alarm information is determined as prompt information.

In some embodiments, the playground system takes the received alarm information as the prompt information, to prompt the game manager of artificially associating the token and the gamer. Therefore, the edge device takes the unique ID generated for the token as the key, takes the position information of the token as the value to store to a cache, and takes the ID and the position information as the alarm information (i.e., the prompt information) to transmit to the playground system, and can timely remind the manager of artificially associating the token.

In some embodiments, the alarm information sent to the management end further includes the first object information. In this way, when feeding back the second object information, the management end manually associates the first object information with the second object information and then returns management information, with the implementation process as follows.

Association information sent in response to the request is received, where the association information includes the first object information and the second object information associated with the first object information. In this way, an Artificial Intelligence (AI) node may know which first object has the object information associated with the returned second object information; and if there are multiple first objects that need to be manually associated, the management on the first objects and the second objects may be not in disorder.

In some possible implementation modes, first of all, after the gamer information with which the game manager manually associates the game prop is acquired, the gamer corresponding to the gamer information in the preset second object library is taken as the gamer possessing the game prop, i.e., the preset second object. Then, an association relationship between the gamer and the game prop may be established based on a gamer image and identity information in the preset second object library.

In the embodiment of the present application, for the first object not associated to the second object information, the manager manually associates the second object information of the first object by viewing an face of the gamer. Therefore, the process for establishing the association relationship between the first object and the second object is simple in logic, strong in constraint condition and easy in implementation, and can ensure the association accuracy.

In some embodiments, with a case where the object operation region is the game prop operation region, the first object is the token and the second object is the gamer as an example, after the association relationship between the token and the gamer is established by the game manager in the artificial association manner, the edge device assigns gamer information of the gamer to the token, to facilitate the subsequent association process of the object information, which may be implemented through the following process.

In a first step, the manually associated gamer information is sent to the edge device.

In some embodiments, the playground system feeds gamer information specified by the manager back to the edge device.

In a second step, the edge device determines a tracking ID of the token based on the gamer information.

In some embodiments, the edge device finds the tracking ID of the token in the cache system based on the gamer information.

In a third step, the edge device binds the gamer information with the tracking ID to obtain an association relationship.

In some embodiments, the edge device filters a token having the tracking ID from multiple tokens of the game according to the tracking ID, and assigns gamer information to the token, thereby establishing an association relationship between the token and the gamer information of the gamer.

In the embodiment of the present application, by artificially viewing the face of the gamer, the manager specifies the second object (i.e., the gamer) possessing the token as the first object; the playground system feeds gamer information manually associated by the manager back to the edge device, and the edge device binds the gamer information with the token to establish an association relationship between the token and the gamer. Therefore, even though a clear gamer image or a clear token image cannot be collected, the token may still be associated with the gamer in an artificial association manner, and thus the problem of an association failure between the gamer information and the token in actual gaming can be effectively solved.

In some embodiments, the alarm information sent to the management end may further include an image of a first object not associated to the second object information, and a face image of a second object associated with the first object, such that the manager of the management end queries the preset second object library to manually associate the first object with the second object, with the implementation process as follows.

Image information of the second object is extracted from the video stream.

In some possible implementation modes, the request further includes: image information of a second object that fails to be matched with the preset second object. Feature extraction is performed on the video stream to obtain the image information of the second object. With a case where the object operation region is the game prop operation region as an example, a face image of the gamer as the second object is extracted from the video stream collected from the game scenario; and the face image is carried in the alarm information to send to the management end, i.e., the alarm information of the game manager includes an image of a game prop not associated to the gamer information, and a face image of a gamer associated with the game prop, such that the game manager queries the person list, and thus can accurately associate the game prop with the gamer.

An exemplary application of the embodiment of the present application in an actual application scenario will be described below. The descriptions are made by taking a case where the game site is a casino, the game is a gambling game in the casino, and the token is a chip as an example.

In some possible implementation modes, with a Baccarat game as an example, the Baccarat game is a card game that the dealer extracts 4 to 6 cards from 3 to 8 decks of cards and outputs a win-lose result according to a rule. The win-lose result is classified into: player, banker, tie, super six, etc. The gamer and the casino calculate respective gains and loses of money according to the win-lose result in each game, odds at different scenarios and whether to charge a commission. There are certain rules for the dealer to deal cards and the gamer to squint the card; and in case of any violation to the rules, the playground system will send alarm information.

Chip association mainly indicates that which gamer possesses the present betting chip. Through the chip association, the betting amount of the gamer at the present game, as well as the win-lose result of the gamer at the end of the game may be calculated. Meanwhile, whether the membership chip belongs to the gamer is detected, such that the casino makes a portrait for the gamer. In some possible implementation modes, members of the casino are divided into different levels, and the chip that may be used by the members of different levels is specified in advance. If the type of the chip used by the gamer does not belong to the gamer, an alarm is notified to the dealer for check. However, due to uncontrollable factors of the gamer in the gaming process (for example, the gamer lowers his/her head during betting, such that the camera cannot capture the face information; or, the gamer wears a mask during betting such that the quality of face captured has a low score; or, the gamer has a high speed during betting to cause an association failure, etc.), the chip cannot be associated to the gamer information, and thus which gamer bets the chip cannot be determined.

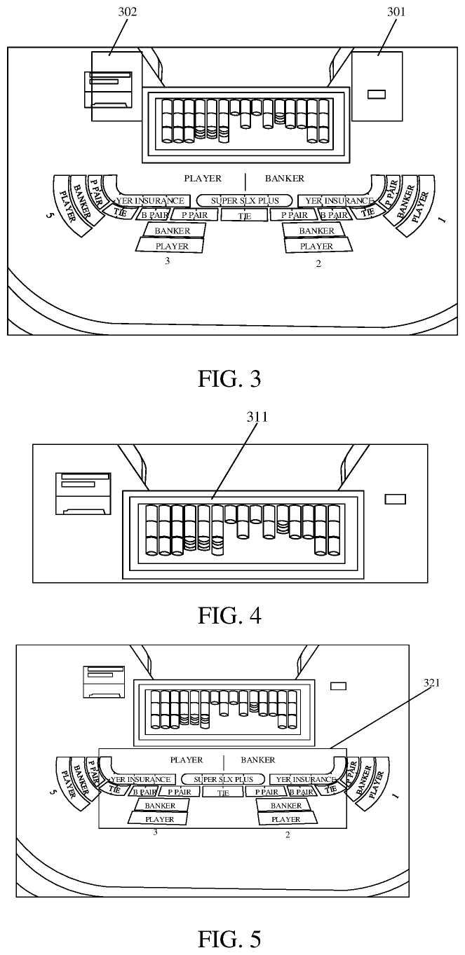

In view of this, the embodiments of the present application provide a game site management method. Under the scenario of an intelligent casino, in the Baccarat game, three cameras are used to detect events on the table, and converts the events into computer information to transmit to a service system for analysis. The service system performs data cleaning on input data, and speculates the detected and recognized data with an analytical algorithm, the data including a marker, a poker, a chip cash, etc. According to different table types of the Baccarat game, the hot region map, such as photos of the gambling tables from the top (i.e., reference maps), is divided into several hot regions such as player, banker, p_pair and b_pair, as shown in FIG. 3. FIG. 3 is a structural schematic diagram of a hot region map provided by an embodiment of the present application, where the hot region 301 represents a left region where the hand of the dealer is located, and the hot region 302 represents a right region where the hand of the dealer is located.

FIG. 4 is another structural schematic diagram of a hot region map provided by an embodiment of the present application. The hot region 311 represents a region where a chip box on the side of an game controller is located.

FIG. 5 is still another structural schematic diagram of a hot region map provided by an embodiment of the present application. The hot region 321 (i.e., the shadow region) covers a region for temporarily storing the cash on the game table.

The above detected and recognized data is mapped to different hot regions for filtering, and different service modules in the service system process data in corresponding hot regions according to respective service and detection functions. In the embodiment of the present application, first of all, three cameras are mounted to detect objects, coordinates and behaviors on the table, and converts them into the computer language to transmit to the service module for analysis; and then, assignment is performed on chip and gamer information based on a detection and recognition result provided by the algorithm side and the query of the service side; and data in each state is independently cached in the service layer, and the caching is reset whenever the game starts. Therefore, the problem of an association failure between the gamer information and the chip in actual gaming can be effectively solved with the smaller cost and the higher speed.

The game site management method provided by the embodiments of the present application may be implemented through the following process.

In a first step, a game stage is detected, and manual association is detected in betting and gaming stages of the game.

In some embodiments, the game stage is divided into an idle state (identified as “le”), the betting stage, the gaming stage, a payout state and a halt state. During the game, only the betting and gaming stages allow the gamer to make a bet, i.e., the manual association is only performed in these two stages.

In a second step, a configuration file issued by the casino is monitored by a message-oriented middleware in real time, and the configuration file is updated in real time, to ensure that functions are detected according to requirements of the casino system.

In a third step, whether a present function is enabled is determined according to a manual association enabled value sent by the casino. If the function is enabled, a chip type needing to be detected is filtered according to a chip type needing to be manually associated (the type is specified by the casino and sent through the configuration file) and a chip association result (i.e., a person query result associated with the chip). The chip type needing to be detected refers to that the chip type needs to be manually associated and the gamer information cannot be queried according to the chip association ID.

In some embodiments, for the on-off solution implemented by the manual association function, on and off may be switched at any time. Moreover, the manual association implements logic processing on a special chip type, and is to filter an unnecessary chip type, thereby alleviating the pressure of the dealer, and ensuring smooth operation of the game.

In a fourth step, person information is queried through the association ID according to chip information output by the algorithm side. The process may be implemented through the following process.

First of all, the algorithm side associates the chip, hand, body and face to determine a gamer betting the chip.

In some possible implementation modes, first of all, the association ID of the chip is generated through in the form of a key value, and the captured picture for the face of the gamer is intercepted; and the association ID and the captured picture are added to the cache. Then, assignment is performed on the association ID of the chip. If the association fails, it is unnecessary to write the association ID into the cache but the association ID of the chip needs to be assigned as −3.

Then, the service side queries a captured picture, corresponding to the analysis layer and stored to the cache system, through the association ID of the chip according to the read chip information. By extracting a feature value of the captured picture, and calling an image system of the casino to perform the operation of searching the image with the image, person information recorded by the gamer in the casino system is queried.

In a fifth step, the chip meets the requirement of the third step, and the chip needs the manual association operation.

In some embodiments, the chip meets the requirement of the third step, i.e., the chip belongs to the chip type needing to be manually associated and the gamer information cannot be queried according to the association ID of the chip.

The fifth step may be implemented through the following process.

First of all, a unique ID is generated for the chip to take as a key, and information of the chip is stored to the cache as a value; according to the generated unique ID, the unique ID and the chip information are transmitted to the casino system through the websocket as alarm information; and meanwhile, the chip is filtered from the present frame of information, and premium verification check is not performed on the chip.

Next, the casino system receives the alarm information, and queries a person list according to a person system in the casino. The dealer views the face of the gamer to artificially confirm the information of the gamer in the casino system, recombines the unique ID with the gamer information, and notifies the intelligent service system through a message queue.

At last, according to the gamer information synchronized in the casino system, a tracking ID of the chip information is found in the cache; and then, the chip in the present frame is filtered according to the tracking ID, and the gamer information is assigned to the tracking ID.

In some embodiments, by synchronizing the associated personnel information, detection on the normal service process of the chip, such as the premium verification check and gamer betting record, can be ensured after the artificial association.

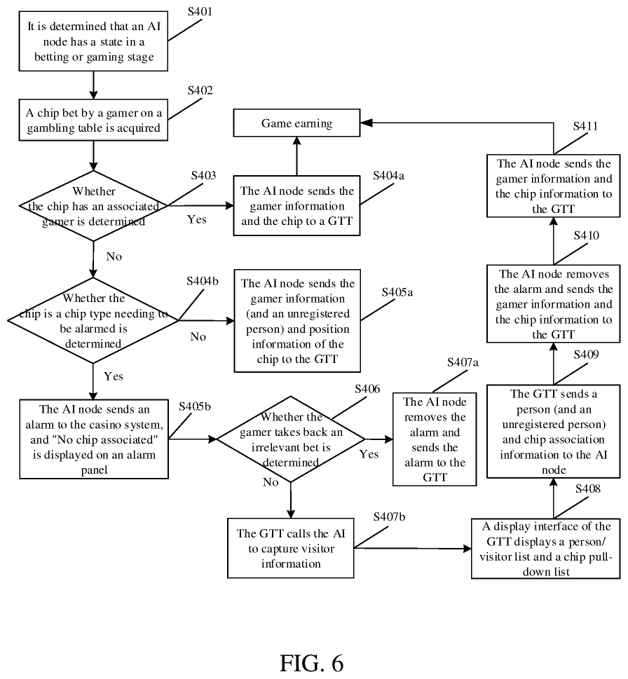

FIG. 6 is an implementation flowchart of a game site management method provided by an embodiment of the present application. The descriptions are made below in combination with FIG. 6.

In Step S401, it is determined that an AI node has a state of a betting stage or a gaming stage.

In some embodiments, the AI node has the state of the betting stage or the gaming stage, which indicates that the game is in the betting stage or the gaming stage. The AI node may be disposed in the casino system in the form of an edge device.

In Step S402, a chip bet by a gamer on a gambling table is acquired.

In some embodiments, the game is in the betting or gaming stage, and the gamer bets the chip.

In Step S403, whether the chip has an associated gamer is determined.

In some embodiments, if the chip has the associated gamer, Step S404a is entered. If the chip does not have the associated gamer, Step S404b is entered.

In Step S404a, the AI node sends the gamer information and the chip to a Global Title

Translation (GTT).

In Step S404b, whether the chip is a chip type needing to be alarmed is determined.

In some embodiments, if the chip is not the chip type needing to be alarmed, Step S405a is entered. If the chip is the chip type needing to be alarmed, Step S405b is entered.

In Step S405a, the AI node sends the gamer information (and an unregistered person) and position information of the chip to the GTT.

In Step S405b, the AI node sends an alarm to the casino system, and “No chip associated” is displayed on an alarm panel.

In some embodiments, if the corresponding gamer information is not queried, whether the chip type of the chip is included in the chip type needing to be alarmed is detected; and if the alarm is not needed, the chip information is directly sent to the GTT; and if the alarm is needed, an artificial association alarm is sent.

In Step S406, whether the gamer takes back an irrelevant bet is determined.

In some embodiments, if the gamer takes back the irrelevant bet, Step S407a is entered; and if the gamer does not take back the irrelevant bet, Step S407b is entered.

In Step S407a, the AI node removes the alarm and sends the alarm to the GTT.

In Step S407b, the GTT calls the AI node to capture visitor information.

In Step S408, a display interface of the GTT displays a person/visitor list and a chip pull-down list.

In Step S409, the GTT sends a person (and an unregistered person) and chip association information to the AI node.

In Step S410, the AI node removes the alarm and sends the gamer information and the chip information to the GTT.

In Step S411, the AI node sends the gamer information and the chip information to the GTT.

At last, Step S404a, Step S405a, Step S407a and Step S411 enter the final game earning stage.

In the embodiment of the present application, the game is first divided into five states; and during the game, the gamer is allowed to make the bet only in the betting stage and the gaming stage, i.e., the artificial association is only detected in these two stages. Next, for the on-off solution implemented by the artificial association function, the artificial association function may be switched on and off at any time; then, logic processing is performed on a special chip type through the artificial association to filter the unimportant chip type, thereby alleviating the pressure of the dealer and ensuring the smooth operation of the game; and at last, the associated person information is synchronized, so as to ensure the detection of the normal service process on the chip, such as the premium verification check and gamer betting record, after the artificial association.

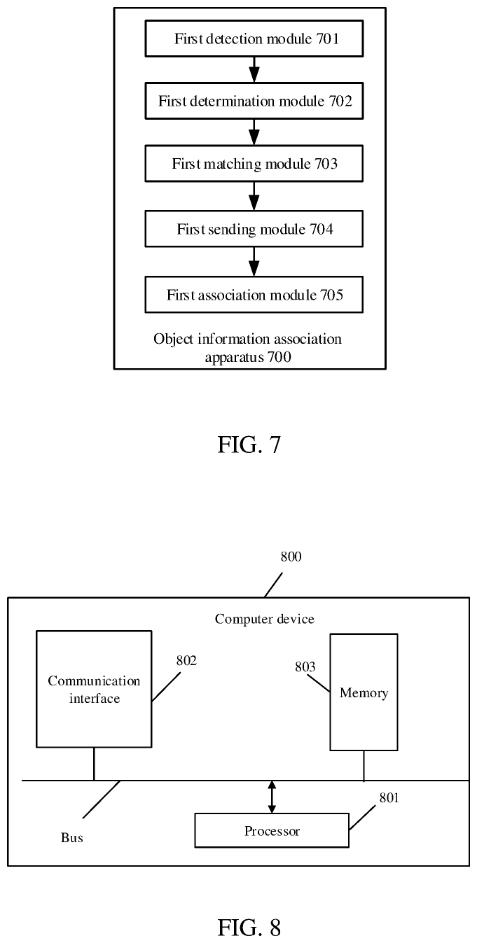

The embodiments of the present application provide an object information association apparatus. FIG. 7 is a structural schematic diagram of an object information association apparatus according to an embodiment of the present application. As shown in FIG. 7, the object information association apparatus 700 may include: a first detection module 701, a first determination module 702, a first matching module 703, a first sending module 704 and a first association module 705.

The first detection module 701 is configured to detect, based on a video stream of an object operation region, a first object and a second object that are mutually associated in the object operation region.

The first determination module 702 is configured to determine first object information of the first object.

The first matching module 703 is configured to match the second object with a preset second object in a preset second object library.

The first sending module 704 is configured to send, in a case where the second object fails to be matched with the preset second object, a request for acquiring second object information of the second object.

The first association module 705 is configured to associate the first object information with the received second object information in a case where the second object information sent in response to the request is received.

In some embodiments, the apparatus may further include: a second acquisition module and a second management module.

The second acquisition module is configured to acquire, in a case where the second object is successfully matched with the preset second object, second object information of the successfully matched preset second object from the preset second object library.

The second management module is configured to associate the first object information with the second object information of the successfully matched preset second object.

In some embodiments, the first detection module 701 may include: a first detection submodule, a second detection submodule and a first determination submodule.

The first detection submodule is configured to detect the first object and the second object based on the video stream of the object operation region, where the first object is an object capable of being operated, and the second object is an object capable of executing an operation behavior.

The second detection submodule is configured to detect an operation relationship between each first object and each second object.

The first determination submodule is configured to determine, for each first object, a second object detected to have an operation relationship with the first object as the second object mutually associated with the first object.

In some embodiments, the first detection module 701 is further configured to: determine, for each first object, in a case where the second object having the operation relationship with the first object is not detected, that the object operation region does not have the second object mutually associated with the first object.

In some embodiments, the object operation region may include a game prop operation region, the first object may include a game prop, the second object may include a game participant, and the first detection module 701 is further configured to: detect, in a case where a game stage in the object operation region is determined as a preset first object operation stage based on the video stream, a game prop and a game participant that are mutually associated in the object operation region, based on the video stream of the object operation region.

In some embodiments, the first sending module 704 is further configured to: send, in a case where the first object meets a preset candidate object condition and the second object fails to be matched with the preset second object, the request for acquiring the second object information of the second object.

In some embodiments, the apparatus may further include: a third acquisition module and a second determination module.

The third acquisition module is configured to acquire configuration information of the object association operation, the configuration information including on-off state information of a manual association object function and object type information corresponding to the manual association object function.

The second determination module is configured to determine, in a case where the on-off state information indicates that the manual association object function is enabled, that the candidate object condition includes a type of an object being consistent with the object type information.

In some embodiments, the first detection module 701 may further include: a second acquisition submodule and a first sending submodule.

The second acquisition submodule is configured to acquire, for each first object, in the case where the second object having the operation relationship with the first object is not detected, an association ID of the first object.

The first sending submodule is configured to send, based on the association ID, a request for acquiring a second object having an operation relationship with the first object.

In some embodiments, the object operation region may include a game prop operation region, the first object may include a game prop, and the second object may include a game participant; and the apparatus may further include: a third acquisition submodule and a first establishment submodule.

The third acquisition submodule is configured to acquire a face image and identity information of a gamer entering the game prop operation region.

The first establishment submodule is configured to establish the preset second object library based on the face image and the corresponding identity information of the game participant.

In some embodiments, the first object information may include a tracking ID of the game prop, and the second object information may include: a face image and/or identity information of the second object.

In some embodiments, the first sending module 704 may further include: a second sending submodule and a first removal submodule.

The second sending submodule is configured to send alarm information in the case where the second object fails to be matched with the preset second object.

The first removal submodule is configured to remove the alarm information in a case of detecting that the first object is moved out of the object operation region.

In some embodiments, the request may include: first object information of a first object associated with the second object that fails to be matched with the preset second object, and the first sending module 704 is further configured to: receive association information sent in response to the request, where the association information may include the first object information and the second object information associated with the first object information.

In some embodiments, the apparatus may further include: a first extraction module.

The first extraction module is configured to extract image information of the second object from the video stream; and the request may further include: image information of the second object that fails to be matched with the preset second object.

It is to be noted that the descriptions on the above apparatus embodiment are similar to those of the above method embodiment, so the beneficial effects are the same to the method embodiment. A technical detail not disclosed in the apparatus embodiment of the present application may be understood with reference to the descriptions on the method embodiment of the present application.

It is to be noted that, in the embodiment of the present application, when being implemented in the form of a software function module and sold or used as an independent product, the object information association method may also be stored in a computer-readable storage medium. Based on such an understanding, the technical solutions of the embodiments of the present application substantially or parts making contributions to the conventional art may be embodied in the form of software product, and the computer software product is stored in a storage medium, including a plurality of instructions configured to enable a piece of computer equipment (which may be a terminal, a sever and the like) to execute all or part of the method in each embodiment of the present application. The storage medium includes: various media capable of storing program codes such as a U disk, a mobile hard disk, a Read Only Memory (ROM), a magnetic disk or an optical disk. By doing so, the embodiments of the present application are not limited to any specific combination of hardware and software.

Correspondingly, the embodiments of the present application provide a computer program product, which may include a computer executable instruction. After executed, the computer executable instruction can implement steps of the object information association method provided by the embodiments of the present application.

Correspondingly, the embodiments of the present application further provide a computer storage medium, which stores a computer executable instruction thereon; and after executed by a processor, the computer executable instruction implements steps of the object information association method provided by the embodiments of the present application.

Correspondingly, the embodiments of the present application provide a computer device. FIG. 8 is a structural schematic diagram of a computer device according to an embodiment of the present application. As shown in FIG. 8, the computer device 800 may include: a processor 801, at least one communication bus, a communication interface 802, at least one external communication interface and a memory 803. The communication bus 802 is configured to implement connection and communication among these components. The communication bus 802 may include a display screen, and the external communication interface may include standard wired interface and wireless interface. The processor 801 is configured to execute an image processing program in the memory, to implement steps of the object information association method provided by the above embodiment.

The descriptions on the embodiments of the object information association apparatus, computer device and storage medium are similar to those of the above method embodiment, so the technical descriptions and beneficial effects are the same to the corresponding method embodiment, may refer to the disclosures of the method embodiment for the ease of simplicity and will not be repeated herein. A technical detail not disclosed in the embodiments of the object information association apparatus, computer device and storage medium may be understood with reference to the descriptions on the method embodiment of the present application.

It is to be understood that reference throughout this specification to “one embodiment” or “an embodiment” means that particular features, structures, or characteristics described in connection with the embodiment is included in at least one embodiment of the present application. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It is further to be understood that the sequence numbers of the foregoing processes do not mean execution sequences in various embodiments of the present application. The execution sequences of the processes should be determined according to functions and internal logics of the processes, and should not be construed as any limitation to the implementation processes of the embodiments of the present application. The serial numbers of the embodiments of the application are merely for description and do not represent a preference of the embodiments. It is to be noted that the terms “include”, “contain” or any other variations thereof are intended to cover a non-exclusive inclusion, such that a process, method, article or equipment including a series of elements not only includes those elements, but also includes those elements that are not explicitly listed, or includes elements inherent to such a process, method, article or device. Under the condition of no more limitations, it is not excluded that additional identical elements further exist in the process, method, article or device including elements defined by a sentence “including a . . . ”.

In the several embodiments provided in the application, it should be understood that the disclosed device and method may be implemented in other manners. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each function unit in each embodiment of the application may be integrated into a processing unit, each unit may also exist independently, and two or more than two unit may also be integrated into a unit. The integrated unit may be implemented in a hardware form, and may also be implemented in form of hardware and software function unit. Those of ordinary skill in the art should know that: all or part of the steps of the abovementioned method embodiment may be implemented by instructing related hardware through a program, the abovementioned program may be stored in a computer-readable storage medium, and the program is executed to execute the steps of the abovementioned method embodiment; and the storage medium includes: various media capable of storing program codes such as mobile storage equipment, an ROM, a Random Access Memory (RAM), a magnetic disk or an optical disc.

Or, when being implemented in form of software function module and sold or used as an independent product, the integrated unit of the present application may also be stored in a computer-readable storage medium. Based on such an understanding, the technical solutions of the embodiments of the application substantially or parts making contributions to the conventional art may be embodied in form of software product, and the computer software product is stored in a storage medium, including a plurality of instructions configured to enable a piece of computer equipment (which may be a personal computer, a server, network equipment or the like) to execute all or part of the method in each embodiment of the present application. The abovementioned storage medium includes: various media capable of storing program codes such as mobile storage equipment, a ROM, a RAM, a magnetic disk or an optical disc. The above is only the specific implementation mode of the present application and not intended to limit the scope of protection of the present application. Any variations or replacements apparent to those skilled in the art within the technical scope disclosed by the application shall fall within the scope of protection of the present application. Therefore, the scope of protection of the present application shall be subjected to the scope of protection of the claims.

1. An object information association method, comprising:
detecting, based on a video stream of an object operation region, a first object and a second object that are mutually associated in the object operation region;
determining first object information of the first object;
matching the second object with a preset second object in a preset second object library;
sending, in a case where the second object fails to be matched with the preset second object, a request for acquiring second object information of the second object; and
associating the first object information with the received second object information in a case where the second object information sent in response to the request is received.

2. The method of claim 1, further comprising:
acquiring, in a case where the second object is successfully matched with the preset second object, second object information of the successfully matched preset second object from the preset second object library; and
associating the first object information with the second object information of the successfully matched preset second object.

3. The method of claim 1, wherein detecting, based on the video stream of the object operation region, the first object and the second object that are mutually associated in the object operation region comprises:
detecting the first object and the second object based on the video stream of the object operation region, wherein the first object is an object capable of being operated, and the second object is an object capable of executing an operation behavior;
detecting an operation relationship between each first object and each second object; and
determining, for each first object, a second object detected to have an operation relationship with the first object as the second object mutually associated with the first object.

4. The method of claim 3, wherein detecting, based on the video stream of the object operation region, the first object and the second object that are mutually associated in the object operation region further comprises:
determining, for each first object, in a case where the second object having the operation relationship with the first object is not detected, that the object operation region does not have the second object mutually associated with the first object.

5. The method of claim 1, wherein the object operation region comprises a game prop operation region, the first object comprises a game prop, the second object comprises a game participant, wherein detecting, based on the video stream of the object operation region, the first object and the second object that are mutually associated in the object operation region comprises:
detecting, in a case where a game stage in the object operation region is determined as a preset first object operation stage based on the video stream, a game prop and a game participant that are mutually associated in the object operation region based on the video stream of the object operation region.

6. The method of claim 1, wherein sending, in the case where the second object fails to be matched with the preset second object, the request for acquiring the second object information of the second object comprises:
sending, in a case where the first object meets a preset candidate object condition and the second object fails to be matched with the preset second object, the request for acquiring the second object information of the second object.

7. The method of claim 6, wherein before sending, in the case where the first object meets the preset candidate object condition and the second object fails to be matched with the preset second object, the request for acquiring the second object information of the second object, the method further comprises:
acquiring configuration information of an object association operation, wherein the configuration information comprises on-off state information of a manual association object function and object type information corresponding to the manual association object function; and
determining, in a case where the on-off state information indicates that the manual association object function is enabled, that the preset candidate object condition includes a type of an object being consistent with the object type information.

8. The method of claim 1, wherein detecting, based on the video stream of the object operation region, the first object and the second object that are mutually associated in the object operation region further comprises:
acquiring, for each first object, in the case where the second object having an operation relationship with the first object is not detected, an association Identity Document (ID) of the first object; and
sending, based on the association ID, a request for acquiring a second object having an operation relationship with the first object.

9. The method of claim 5, wherein the object operation region comprises a game prop operation region, the first object comprises a game prop, and the second object comprises a game participant; wherein before matching the second object with the preset second object in the preset second object library, the method further comprises:
acquiring a face image and identity information of a gamer entering the game prop operation region; and
establishing the preset second object library based on the face image and the corresponding identity information of the game participant.

10. The method of claim 9, wherein the first object information comprises a tracking ID of the game prop, and the second object information comprises: a face image and/or identity information of the second object.

11. The method of claim 1, wherein sending, in the case where the second object fails to be matched with the preset second object, the request for acquiring the second object information of the second object further comprises:
sending alarm information in the case where the second object fails to be matched with the preset second object; and
removing the alarm information in a case of detecting that the first object is moved out of the object operation region.

12. The method of claim 11, wherein the request comprises: first object information of a first object associated with the second object that fails to be matched with the preset second object, wherein after sending, in the case where the second object fails to be matched with the preset second object, the request for acquiring the second object information of the second object, the method further comprises:
receiving association information sent in response to the request, wherein the association information comprises the first object information and the second object information associated with the first object information.

13. The method of claim 11, wherein the method further comprises:
extracting image information of the second object from the video stream;
wherein the request further comprises: image information of the second object that fails to be matched with the preset second object.

14. A computer storage medium, storing a computer executable instruction, wherein the computer executable instruction, when executed, implements steps of the method of claim 1.

15. A computer device, comprising a memory and a processor, wherein the memory stores a computer executable instruction, wherein the processor, when running the computer executable instruction in the memory, is configured to:
detect, based on a video stream of an object operation region, a first object and a second object that are mutually associated in the object operation region;
determine first object information of the first object;
match the second object with a preset second object in a preset second object library;
send, in a case where the second object fails to be matched with the preset second object, a request for acquiring second object information of the second object; and
associate the first object information with the received second object information in a case where the second object information sent in response to the request is received.

16. The computer device of claim 15, wherein the processor is further configured to:
acquire, in a case where the second object is successfully matched with the preset second object, second object information of the successfully matched preset second object from the preset second object library; and
associate the first object information with the second object information of the successfully matched preset second object.

17. The computer device of claim 15, wherein the processor is configured to:
detect the first object and the second object based on the video stream of the object operation region, wherein the first object is an object capable of being operated, and the second object is an object capable of executing an operation behavior;
detect an operation relationship between each first object and each second object; and
determine, for each first object, a second object detected to have an operation relationship with the first object as the second object mutually associated with the first object.

18. The computer device of claim 17, wherein the processor is further configured to:
determine, for each first object, in a case where the second object having the operation relationship with the first object is not detected, that the object operation region does not have the second object mutually associated with the first object.
